(19) United States
(12) Patent Application Publication
(10) Pub. No.: US 2014/0243188 A1
(43) Pub. Date: Aug. 28, 2014

(54) ALUMINUM SULFATE BOUND CATALYSTS

(71) Applicant: W. R. GRACE & CO.-CONN., Columbia, MD (US)

(72) Inventor: Ranjit KUMAR, Clarksville, MD (US)

(73) Assignee: W. R. GRACE & CO.-CONN., Columbia, MD (US)

(21) Appl. No.: 14/269,905

(22) Filed: May 5, 2014

Related U.S. Application Data
(62) Division of application No. 12/308,726, filed on Dec. 22, 2008.
(60) Provisional application No. 60/818,829, filed on Jul. 6, 2006.

(51) Int. Cl. B01J 29/08

(52) U.S. Cl. CPC B01J 29/088
USPC 502/65; 502/355; 502/64; 502/68

(57) ABSTRACT

Alumina binder obtained from aluminum sulfate, the process of preparing the binder and the process of using the binder to prepare catalyst compositions are disclosed. Catalytic cracking catalyst compositions, in particularly, fluid catalytic cracking catalyst composition comprising zeolites, optionally clay and matrix materials bound by an alumina binder obtained from aluminum sulfate are disclosed.

### FIELD OF THE INVENTION

The present invention relates to novel compositions bound by an alumina binder obtained from aluminum sulfate, the process of preparing the compositions and the process of using the compositions.

### BACKGROUND OF THE INVENTION

Particulate inorganic compositions are useful as catalysts and catalyst supports, and generally comprise small microspherodial particles of inorganic metal oxides bound with a suitable binder. For example, a hydrocarbon conversion catalyst, e.g. fluid catalytic cracking (FCC) catalyst, typically comprises crystalline zeolite particles, and optionally clay particles and matrix materials (e.g. alumina, silica and silica-alumina particles), bound by a binder. Suitable binders have included silica, alumina, silica-alumina, hydrogel, silica sol and alumina sol binder.

Particulate catalyst compositions have been described and disclosed in various patents. U.S. Pat. Nos. 3,957,689 and 5,135,756 disclose a sol based FCC catalyst comprising particles of zeolite, alumina, clay and a silica sol binder.

U.S. Pat. Nos. 4,086,187 and 4,206,085 disclose particulate catalyst compositions containing silica, alumina and clay components wherein the alumina has been peptized with an acid.

U.S. Pat. No. 4,458,023 discloses zeolite containing particulate catalysts prepared from zeolite, an aluminum chlorohydrol binder, and optionally, clay.

U.S. Pat. Nos. 4,480,047 and 4,219,406 discloses particulate catalyst compositions bound with a silica alumina hydrogel binder system.

Catalyst manufacturers are continuously seeking methods to lower the costs of producing catalysts by lowering the cost of raw materials. Consequently, there exists a need for efficient and economical compositions and processes for the production of particulate inorganic metal oxide compositions which are useful as catalyst and/or catalyst support compositions.

### SUMMARY OF THE INVENTION

The present invention is directed to economical particulate compositions which comprise a plurality of inorganic metal oxide particles bound with an alumina binder formed from aluminum sulfate. In a preferred embodiment of the invention, particulate catalyst compositions, in particularly fluid catalytic cracking catalyst compositions, are provided. Compositions of the invention are economical and possess sufficient attrition properties to be suitable for use as catalysts and/or catalyst supports.

In accordance with the invention, the particulate compositions comprise a plurality of inorganic metal oxide particles and a sufficient amount of aluminum sulfate to provide an alumina binder which functions to bind the inorganic metal oxide particles and form a particulate composition. The particulate compositions are thereafter treated to remove all or substantially all sulfate ions and provide a binder primarily comprised of alumina obtained from aluminum sulfate.

Particulate compositions of the invention are preferably useful as catalyst compositions. In a more preferred embodiment of the invention, the particulate compositions are fluid catalytic cracking (FCC) catalyst compositions which generally comprise particles of zeolite, clay, and optionally matrix materials, bound with an alumina binder formed from aluminum sulfate. Advantageously, FCC catalyst compositions of the invention exhibit increased bottom cracking and decreased coke production during an FCC process as compared to an FCC catalyst comprising an alumina binder obtained from conventional sources, e.g. aluminum chlorohydrol.

The particulate compositions are generally prepared by spraying an aqueous slurry comprising a plurality of inorganic metal oxide particles and a sufficient amount of aluminum sulfate to bind the inorganic metal oxide particles and form a inorganic metal oxide particulate material. Thereafter, the particulate composition is re-slurried in an aqueous base to remove all or substantially all sulfate ions thereby forming an alumina containing binder.

Accordingly, it is an advantage of the present invention to provide economical particulate inorganic metal oxide compositions bound with a binder obtained from aluminum sulfate.

It is also an advantage of the present invention to provide economical catalyst compositions bound with an alumina binder obtained from aluminum sulfate.

It is another advantage of the present invention to provide economical fluid catalytic cracking catalyst compositions having good attrition properties under catalytic cracking conditions.

It is another advantage to provide fluid catalytic cracking catalyst compositions having increased bottoms cracking and decreased coke production under catalytic cracking conditions.

It is a further advantage of the present invention to provide a process of preparing particulate inorganic metal oxide compositions bound with a binder prepared from aluminum sulfate.

It is a further advantage of the present invention to provide a process of preparing economical particulate inorganic metal oxide catalyst compositions employing an alumina binder obtained from aluminum sulfate.

Another advantage of the present invention is to provide a process of preparing economical fluid catalytic cracking catalyst compositions which exhibit good attrition properties, increased bottoms cracking and decreased coke production during an FCC process.

It is also an advantage of the present invention to provide improved FCC processes using compositions and processes in accordance with the present invention.

These and other aspects of the present invention are described in further details below.

### DETAILED DESCRIPTION OF THE INVENTION

Particulate compositions of the invention generally comprise a plurality of inorganic metal oxide particles and an alumina binder obtained from aluminum sulfate. Unexpectedly, the use of low cost aluminum sulfate as a binder source provides particulate inorganic metal oxide compositions having attrition properties sufficient to be useful catalysts or catalyst supports.

The particulate compositions of the invention are generally prepared by forming an aqueous slurry containing a plurality of inorganic metal oxide particles and aluminum sulfate. The slurry may be formed by mixing the inorganic metal oxide particles directly into an aqueous solution of aluminum sulfate or by pre-forming a separate aqueous slurry of inorganic metal oxide particles and an aqueous solution of aluminum sulfate and thereafter mixing the slurries to form the aqueous slurry containing the inorganic metal oxide particles and aluminum sulfate.

Optionally, the aqueous slurry is milled to obtain a homogeneous or substantially homogeneous slurry and to ensure that all solid components of the slurry have an average particle size of less than about 20 microns. Alternatively, the components of the slurry may be milled prior to forming the slurry.

Thereafter, the aqueous inorganic metal oxide and aluminum sulfate containing slurry is subjected to spray drying using conventional, spray drying techniques. During spray drying, the slurry is converted to a composite inorganic metal oxide particulate composition which comprise a plurality of inorganic metal oxide particles bound with aluminum sulfate. The spray dried composition typically has an average particle size on the order of about 40 to about 150 microns.

Following spray drying, the particulate compositions are optionally calcined. Generally, the particulate compositions are calcined at temperatures ranging from about 150° C. to about 600° C. for a period of about 2 hours to about 10 minutes.

Prior to or subsequent to calcination, the inorganic metal oxide particulate compositions may be treated to remove all or substantially all sulfate ions. For purposes of this invention, the term “substantially all” as it relates to the removal of sulfate ions in the present invention, is used herein to indicate removing sulfate ions from the particulate compositions to the extent that less than 10 wt %, preferably less than 6 wt % and more preferably, less than 4 wt %, sulfate ions remains in the final particulate compositions. Removal of sulfate ions may be accomplished by re-slurrying the particulate compositions in an aqueous solution containing a base, e.g. ammonium hydroxide, sodium hydroxide, potassium hydroxide and mixtures thereof, in an amount sufficient to maintain a pH of about 7 to about 13, preferably about 7.5 to about 11, in the aqueous solution. Removal of sulfate ions provides a binder comprising alumina obtained from aluminum sulfate.

The temperature during the re-slurry process typically ranges from about 1° C. to about 100° C. Preferably, the temperature is maintained at about 4° C. to about 75° C. for about 1 minute to about 3 hours.

The resulting particulate composition may thereafter be treated to remove any residual alkali metal ion by ion exchange and/or subsequent washing steps. The ion exchange step is typically conducted using water and/or aqueous ammonium salt solutions, such as ammonium sulfate solution, and/or solutions of polyvalent metals such as rare earth chloride solutions. Typically, these ion exchange solutions contain from about 0.1 to about 30 weight percent dissolved salts. Frequently, it is found that multiple exchanges are beneficial to achieve the desired degree of alkali metal oxide removal. Typically the exchanges are conducted at temperatures on the order of from about 50° to about 100° C.

Subsequent to ion exchanging, the catalyst components are washed, typically with water, to lower the soluble impurity level to a desirable level.

Subsequent to ion exchange and/or washing, the particulate compositions are dried, typically at temperatures ranging from about 100° C. to about 200° C. to lower the moisture content thereof to a desirable level, typically below about 30 percent by weight.

Aluminum sulfate used in the practice of the present invention is any aluminum sulfate readily available from commercial sources and typically possess the formula, Al₂(SO₄)₃. Aqueous aluminum sulfate solutions useful in the present invention may be prepared by dissolving solid aluminum sulfate in water. Typically, the aluminum sulfate solutions will contain from about 4 to about 9 wt % alumina. Particulate compositions of the invention are bound with alumina obtained from aluminum sulfate by removal of all or substantially all sulfate ions. Typically, the particulate compositions of the invention comprise at least 5 wt % alumina obtained from aluminum sulfate. In a preferred embodiment of the invention, particulate compositions of the invention comprise from about 5 to about 25 wt % alumina from aluminum sulfate. In an even more preferred embodiment of the invention, particulate compositions of the invention comprise from about 6 to about 18 wt % alumina from aluminum sulfate. In a most preferred embodiment of the invention, particulate compositions of the invention comprises from about 7 to about 15 wt % alumina from aluminum sulfate.

Inorganic metal oxide materials useful to prepare the compositions of the present invention may be any inorganic metal oxide materials having the sufficient properties and stability depending upon the intended use of the final composition. In general, suitable inorganic metal oxide materials include those selected from the group consisting of silica, alumina, silica-alumina, oxides of transition metals selected from Groups 3, 4, 5, 6, 7, 8, 9, 10, 11, 12 according to the New Notations of the Periodic Table, oxides of rare earths, oxides of alkaline earth metals and mixtures thereof. Preferred transition metal oxides include, but are not limited to, oxides of iron, zinc, vanadium and mixtures thereof. Preferred oxides of rare earths include, but are not limited to, ceria, yttria, lanthana, praesodemia, neodimia and mixtures thereof. Preferred oxides of alkaline earth include, but are not limited to, oxides of calcium, magnesium and mixtures thereof. As will be understood by one skilled in the arts, the amount of a given inorganic metal oxide material used to prepare the compositions of the invention will vary depending upon the intended use of the final composition. When the compositions of the invention are used as a catalytic cracking catalyst, the inorganic metal oxide material may comprise a zeolite as described hereinbelow.

As will be understood by one skilled in the arts, metal oxide compositions in accordance with the invention will have varying particle sizes depending on the intended use. Typically, however, the metal oxide compositions of the invention will have an average particle size ranging from about 40 to about 150 microns, preferably from about 60 to about 120 microns.

Advantageously, metal oxide compositions of the invention exhibit a good degree of attrition resistance. Typically, compositions in accordance with the invention have a Davison Attrition Index (DI) of less than 30, preferably less than 20.

Particulate compositions in accordance with the invention may be useful in various applications, in particularly as catalysts and/or catalyst supports. In a preferred embodiment particulate compositions of the invention are useful as a catalytic cracking catalyst. In a more preferred embodiment, inorganic metal oxide compositions of the invention are useful as fluid catalytic cracking catalysts.

When used as a catalytic cracking catalyst, particulate compositions of the invention will typically comprise a zeolite, alumina binder obtained from aluminum sulfate and optionally clay and matrix materials.

The zeolite component useful in the invention composition may be any zeolite which has catalytic cracking activity under catalytic cracking conditions, in particular, fluid catalytic cracking conditions. Typically the zeolitic component is a synthetic faujasite zeolite such as sodium type Y zeolite (NaY) that contains from about 10 to about 15 percent by weight Na₂O. Alternatively, the faujasite zeolite may be a USY or REUSY faujasite zeolite. It is contemplated within the scope of the present invention that the zeolite component may be hydrothermally or thermally treated before incorporation into the catalyst. It is also contemplated that the zeolites may be partially ion exchanged to lower the soda level thereof prior to incorporation in the catalyst. Typically, the zeolite component may comprise a partially ammonium exchanged type Y zeolite NH₄NaY which will contain in excess of 0.5 percent and more frequently from about 3 to about 6 percent by weight Na₂O. Furthermore, the zeolite may be partially exchanged with polyvalent metal ions such as rare earth metal ions, calcium and magnesium. The zeolite may be exchanged before and/or after thermal and hydrothermal treatment. The zeolite may also be exchanged with a combination of metal and ammonium and/or acid ions. It is also contemplated that the zeolite component may comprise a mixture of zeolites such as synthetic faujasite in combination with mordenite, Beta zeolites and ZSM type zeolites. Generally, the zeolite cracking components comprises from about 5 to about 80 wt % of the cracking catalyst. Preferably the zeolitic cracking components comprises from about 10 to about 70 wt %, most preferably, from about 20 wt % to about 65 wt %, of the catalyst composition.

Catalytic cracking catalysts in accordance with the present invention may optionally include clay. While kaolin is the preferred clay component, it is also contemplated that other clays, such as pillard clays and/or modified kaolin (e.g. metakaolin), may be optionally included in the invention catalyst. When used, the clay component will typically comprise up to about 75 wt %, preferably about 10 to about 65 wt %, of the catalyst composition.

Catalytic cracking catalyst compositions of the invention may also optionally comprise at least one or more matrix material. Suitable matrix materials optionally present in the catalyst of the invention include alumina, silica, silica-alumina, and oxides of rare earth metals and transition metals. The matrix material may be present in the invention catalyst in an amount of up to about 60, preferably about 5 to about 40 wt % of the catalyst composition.

The particle size and attrition properties of the cracking catalyst affect fluidization properties in the catalytic cracking unit and determine how well the catalyst is retained in the commercial unit, especially in an FCC unit. When used as a catalytic cracking catalyst, compositions of the invention will typically have a mean particle size of about 40 to about 150 μm, more preferably from about 60 to about 120 μm. Compositions of the invention have good attrition properties, as measured by the Davison Attrition Index (DI). Typically, compositions of the invention have a DI value of less that 30, more preferably less than 25 and most preferably less than 20.

Catalytic cracking catalyst compositions in accordance with the present invention are formed from an aqueous slurry which comprises aluminum sulfate in an amount sufficient to provide at least 5 wt %, preferably from about 5 to about 25 wt %, most preferably from about 7 to 15 wt %, alumina obtained from aluminum sulfate in the final catalytic cracking catalyst composition, about 5 to about 80 parts by weight of a zeolite component, and optionally, from about 0 to about 80 wt % of day and matrix materials. The aqueous slurry is milled to obtain a homogeneous or substantially homogeneous slurry and to ensure that all the solid components of the slurry have an average particle size of less than 20 microns. Alternatively, the components forming the slurry are milled prior to forming the slurry to provide solids having an average particle size of less than 20 microns within the slurry. The slurry is thereafter mixed to obtain a homogeneous or substantially homogeneous aqueous slurry.

The aqueous slurry is thereafter subjected to a spraying step wherein the slurry is spray dried using conventional spray drying techniques. During the spray drying step, the slurry is converted to a particulate solid composition that comprise zeolite bound by aluminum sulfate. The spray dried catalyst particles typically have an average particle size on the order of about 40 to about 150 microns.

Following spray drying, the catalyst particles are calcined at temperatures ranging from about 150° C. to about 600° C. for a period of about 2 hours to about 10 minutes. Preferably, the catalyst particles are calcined at a temperature ranging from about 250° C. to about 450° C. for about forty minutes.

Subsequent to calcination, the catalyst particles are re-slurried in an aqueous base solution to remove all or substantially all sulfate ions and form a binder comprising alumina throughout the catalyst particles. The aqueous base solution comprises water and a base, e.g. ammonium hydroxide, sodium hydroxide, potassium hydroxide and mixtures thereof, in an amount sufficient to maintain a pH of about 7 to about 13, preferably about 7.5 to about 11, during the re-slurry step. The temperature during the re-slurry step ranges from about 1° C. to about 100° C.; preferably the temperature is maintained from about 4° C. to about 75° C., for about 1 minute to about 3 hours.

The catalyst particles may thereafter be optionally ion exchanged and/or washed, preferably with water, to remove excess alkali metal oxide and any other soluble impurities. The washed catalyst particles are separated from the slurry by conventional techniques, e.g. filtration, and dried to lower the moisture content of the particles to a desired level, typically at temperatures ranging from about 100° C. to 300° C.

The primary components of FCC catalyst compositions in accordance with the present invention comprise zeolite, matrix materials and optionally, clay and matrix materials, i.e. alumina, silica, and silica-alumina. It is further within the scope of the present invention that catalyst compositions of the invention may be used in combination with other additives conventionally used in a catalytic cracking process, e.g. SOₓ reduction additives, NOₓ reduction additives, gasoline sulfur reduction additives, CO combustion promoters, additives for the production of light olefins, and the like.

Cracking catalyst compositions of the invention are especially useful under catalytic cracking conditions to convert hydrocarbon feedstocks into lower molecular weight compounds. For purposes of this invention, the phrase “catalytic cracking conditions” is used herein to indicate the conditions of a typical catalytic cracking process which involves circulating an inventory of cracking catalyst in a catalytic cracking process, which presently is almost invariably the FCC process. For convenience, the invention will be described with reference to the FCC process although the present cracking process could be used in the older moving bed type (TCC) cracking process with appropriate adjustments in particle size to suit the requirements of the process. Apart from the addition of the catalyst composition of the invention to or as the catalyst inventory, the manner of operating the process will remain unchanged. Thus, in combination with the catalyst compositions of the invention, conventional FCC catalysts may be used, for example, zeolite based catalysts with a faujasite cracking component as described in the seminal review by Venuto and Habib, Fluid Catalytic Cracking with Zeolite Catalysts, Marcel Dekker, New York 1979, ISBN 0-8247-6870-1 as well as in numerous other sources such as Sadeghbeigi, Fluid Catalytic Cracking Handbook, Gulf Publ. Co. Houston, 1995, ISBN 0-88415-290-1. Typically, the FCC catalysts consist of a binder, usually silica, alumina, or silica alumina, a Y type acidic zeolitic active component, one or more matrix aluminas and/or silica aluminas, and fillers such as kaolin clay. The Y zeolite may be present in one or more forms and may have been ultra-stabilized and/or treated with stabilizing cations such as any of the rare earths.

The term “catalytic cracking activity” is used herein to indicate the ability to catalyze the conversion of hydrocarbons to lower molecular weight compounds under catalytic cracking conditions.

Somewhat briefly, the FCC process involves the cracking of heavy hydrocarbon feedstocks to lighter products by contact of the feedstock in a cyclic catalyst recirculation cracking process with a circulating fluidizable catalytic cracking catalyst inventory consisting of particles having a size ranging from about 20 to about 150 μm. The catalytic cracking of these relatively high molecular weight hydrocarbon feedstocks result in the production of a hydrocarbon product of lower molecular weight. The significant steps in the cyclic FCC process are:
(i) the feed is catalytically cracked in a catalytic cracking zone, normally a riser cracking zone, operating at catalytic cracking conditions by contacting feed with a source of hot, regenerated cracking catalyst to produce an effluent comprising cracked products and spent catalyst containing coke and strippable hydrocarbons;
(ii) the effluent is discharged and separated, normally in one or more cyclones, into a vapor phase rich in cracked product and a solids rich phase comprising the spent catalyst;
(iii) the vapor phase is removed as product and fractionated in the FCC main column and its associated side columns to form gas and liquid cracking products including gasoline;
(iv) the spent catalyst is stripped, usually with steam, to remove occluded hydrocarbons from the catalyst, after which the stripped catalyst is oxidatively regenerated in a catalyst regeneration zone to produce hot, regenerated catalyst which is then recycled to the cracking zone for cracking further quantities of feed.

Typical FCC processes are conducted at reaction temperatures of 480° C. to 600° C. with catalyst regeneration temperatures of 600° C. to 800° C. As it is well known in the art, the catalyst regeneration zone may consist of a single or multiple reactor vessels. The compositions of the invention may be used in FCC processing of any typical hydrocarbon feedstock. As will be understood by one skilled in the arts, the useful amount of the invention catalyst compositions will vary depending on the specific FCC process. Typically, the amount of the compositions used is at least 0.1 wt %, preferably from about 0.1 to about 10 wt %, most preferably from about 0.5 to 100 wt % of the cracking catalyst inventory.

Cracking catalyst compositions of the invention may be added to the circulating FCC catalyst inventory while the cracking process is underway or they may be present in the inventory at the start-up of the FCC operation. The catalyst compositions may be added directly to the cracking zone or to the regeneration zone of the FCC cracking apparatus, or at any other suitable point in the FCC process. As will be understood by one skilled in the arts, the amount of catalyst used in the cracking process will vary from unit to unit depending on such factors as the feedstock to be cracked, operating conditions of the FCCU and desired output. Typically, the amount of catalyst used will range from about 1 gm to about 30 gms for every 1 gm of feed. The catalyst of the invention may be used to crack any typical hydrocarbon feedstock. Cracking catalyst compositions of the invention are particularly useful for cracking light to heavy petroleum feedstocks. Advantageously, FCC catalyst compositions of the invention exhibit increased bottom cracking and decreased coke production during an FCC process as compared to catalyst compositions containing an alumina binder obtained from conventional sources, e.g. aluminum chlorohydrol.

To further illustrate the present invention and the advantages thereof, the following specific examples are given. The examples are given as specific illustrations of the claimed invention. It should be understood, however, that the invention is not limited to the specific details set forth in the examples.

All parts and percentages in the examples as well as the remainder of the specification that refers to compositions or concentrations are by weight unless otherwise specified.

Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited.

### EXAMPLES

### Example 1

6750 gms (dry basis) of the USY powder was slurried in the 20833 gms of an aqueous aluminum sulfate solution prepared to contain 7.2 wt % alumina. Then 6750 gms (dry basis) of kaolin clay was added to the slurry. To this slurry, 6000 gms of water was added. The slurry was then milled. The pH of the milled slurry was 3.2: The milled slurry was spray dried. 400 gms of the spray dried material was lab muffle calcined at 371° C. for 40 minutes.

1080 gms of water and 120 gms of the aqua ammonia (ammonium hydroxide solution containing 28-30 wt % NH₃) were mixed and cooled, using ice bath, to 5° C. To this cooled ammonia solution the calcined catalyst was added, and slurried for 10 minutes. The pH and temperature after the 10 minutes were 9 and 29° C., respectively. The slurry was then filtered and rinsed with 75° C. water. The material was then exchanged with rare earths, using the rare earths chloride solution at a pH of 4.9 and at temperature of 75° C. Finally, it was filtered, hot water rinsed, and oven dried. Properties of the resulting material are recorded in Table 1 below.

### Example 2

6750 gms (dry basis) of the USY powder was slurried in the 20833 gms of an aqueous aluminum sulfate solution prepared to contain 7.2 wt % alumina. Next, 1500 gms (dry basis) of boehmite alumina was added. Then 5250 gms. (dry basis) of kaolin clay was added to the slurry. To this slurry, 4000 gms of water was added. The slurry was their milled. The pH of the milled slurry was 3.2. The milled slurry was spray dried.

400 gms of the spray dried material was lab muffle calcined at 371° C. for 40 minutes.

1080 gms of water and 120 gms of the aqua ammonia were mixed and cooled, using ice bath, to 5° C. To this cooled ammonia water the calcined catalyst was added, and slurried for 10 minutes. The pH and temperature after the 10 minutes were 8.8 and 30° C., respectively. The slurry was then filtered and rinsed with 75° C. water. The material was then exchanged with rare earths, using the rare earths chloride solution at a pH of 4.9 and a temperature of 75° C. Finally, it was filtered, hot water rinsed, and oven dried. Properties of the resulting material are recorded in Table 1 below.

### Example 3

5250 gms (dry basis) of the USY powder was slurried in the 16667 gms. of the aluminum sulfate solution prepared to contain 7.2 wt % alumina. Then 8550 gms. (dry basis) of kaolin clay was added to the slurry. To this slurry, 10000 gms of water was added. The slurry was then milled. The pH of the milled slurry was 3.4. The milled slurry was spray dried.

400 gms of the spray dried material was lab muffle calcined at 371° C. for 40 minutes.

1100 gms of water and 100 gms of the aqua ammonia were mixed and cooled, using ice bath, to 5° C. To this cooled ammonia water the calcined catalyst was added, and slurried for 10 minutes. The pH and temperature after the 10 minutes were 8.6 and 25° C., respectively. The slurry was then filtered and rinsed with 75° C. water. The material was then exchanged with rare earths, using the rare earths chloride solution at a pH of 4.9 and a temperature of 75° C. Finally, it was filtered, hot water rinsed, and oven dried. Properties of the resulting material are recorded in Table 1 below.

### Example 4

5250 gms (dry basis) of the USY powder was slurried in the 16667 gms. of the aluminum sulfate solution prepared to contain 7.2 wt % alumina. Next, 1500 gms (dry basis) of boehmite alumina was added. Then 8550 gms. (dry basis) of kaolin clay was added to the slurry. To this slurry, 5000 gms of water was added. The slurry was then milled. The pH of the milled slurry was 3.2. The milled slurry was spray dried.

400 gms of the spray dried material was lab muffle calcined at 371° C. for 40 minutes.

1080 gms of water and 120 gms of the aqua ammonia were mixed and cooled, using ice bath, to 5° C. To this cooled ammonia water the calcined catalyst was added, and slurried for 10 minutes. The pH and temperature after the 10 minutes were 8.8 and 25° C., respectively. The slurry was then filtered and rinsed with 75° C. water. The material was then exchanged with rare earths, using the rare earths chloride solution at a pH of 4.9 and a temperature of 75° C. Finally, it was filtered, hot water rinsed, and oven dried. Properties of the resulting material are recorded in Table 1 below.

### Example 5

3750 gms (dry basis) of the USY powder was slurried in the 12500 gms. of the aluminum sulfate solution prepared to contain 7.2 wt % alumina. Next 3750 gms (dry basis) of boehmite alumina was added. To this slurry, 17246 gms of water was added. Then 6600 gms. (dry basis) of kaolin clay was added to the slurry. The slurry was then milled. The pH of the milled slurry was 3.5. The milled slurry was spray dried.

400 gms of the spray dried material was lab muffle calcined at 371° C. for 40 minutes.

1100 gms of water and 100 gms of the aqua ammonia were mixed and cooled, using ice bath, to 5° C. To this cooled ammonia water, the calcined catalyst was added, and slurried for 10 minutes. The pH and temperature after the 10 minutes were 9.7 and 17° C., respectively. The slurry was then filtered and rinsed with 75° C. water. The material was then exchanged with rare earths, using the rare earths chloride solution at a pH of 4.9 and a temperature of 75° C. Finally, it was filtered, hot water rinsed, and oven dried. Properties of the resulting material are recorded in Table 1 below.

### Example 6

3750 gms (dry basis) of the USY powder was slurried in the 12500 gms. of the aluminum sulfate solution prepared to contain 7.2 wt % alumina. Next, 3750 gms (dry basis) of boehmite alumina was added. To this slurry, 17246 gms of water was added. Then 6600 gms. (dry basis) of kaolin clay was added to the slurry. The slurry was then milled. The pH of the milled slurry was 3.5. The milled, slurry was spray dried.

800 gms of water and 200 gms of the aqua ammonia were mixed and cooled, using ice bath, to 5° C. To this cooled ammonia water, the spray dried catalyst was added, and slurried for 10 minutes. The pH and temperature after the 10 minutes were 10.3 and 18° C., respectively. The slurry was then filtered and rinsed with 75° C. water. The material was then exchanged with rare earths, using the rare earths chloride solution at a pH of 4.9 and a temperature of 75° C. Finally, it was filtered, hot water rinsed, and oven dried. Properties of the resulting material are recorded in Table 1 below.

### Example 7

4000 gms (dry basis) of the USY powder was slurried in the 10624 gms of water. To this slurry 8333 gms of the aluminum sulfate solution prepared to contain 7.2 wt % alumina was added. Next, 2500 gms (dry basis) of Hipal-30 alumina (from Southern Ionics) was added. Then 2900 gms. (dry basis) of kaolin clay was added to the slurry. The slurry was then milled. The pH of the milled slurry was 3.6. The milled slurry was spray dried.

400 gms of the spray dried material was lab muffle calcined at 371° C. for 40 minutes.

1200 gms of water and 42.4 gms of the NaOH pellets were mixed at 75° C. To this solution, the calcined catalyst was added. During the catalyst addition the 8.0-8.5 pH was maintained, using 20% NaOH solution. The pH and temperature were maintained for 10 minutes. The slurry was then filtered and rinsed with 75° C. water. Then it was rinsed with (NH₄)₂SO₄ solution at 75° C. The cake was again rinsed with 75° C. water. The material was then exchanged with rare earths, using the rare earths chloride solution at a pH of 4.9 and a temperature of 75° C. Finally, it was filtered, hot water rinsed, and oven dried. Properties of the resulting material are recorded in Table 1 below.

### Example 8

4000 gms (dry basis) of the USY powder was slurried in the 10575 gms of water. To this slurry 8333 gms of an aqueous aluminum sulfate solution prepared to contain 7.2 wt % alumina was added. Next, 2500 gms (dry basis) of Hipal-40 alumina (from Southern Ionics) was added. Then 2900 gms. (dry basis) of kaolin clay was added to the slurry. The slurry was then milled. The pH of the milled slurry was 3.6. The milled slurry was spray dried.

400 gms of the spray dried material was lab muffle calcined at 371° C. for 40 minutes.

1200 gms of water and 42.4 gms of the NaOH pellets were mixed at 75° C. To this solution, the calcined catalyst was added. During the catalyst addition the 8.0-8.5 pH was maintained, using 20% NaOH solution. The pH and temperature were maintained for 10 minutes. The slurry was then filtered and rinsed with 75° C. water. Then it was rinsed with (NH₄)₂SO₄ solution at 75° C. The cake was again rinsed with 75° C. water. The material was then exchanged with rare earths, using the rare earths chloride solution at pH of 4.9 and a temperature of 75° C. Finally, it was filtered, hot water rinsed, and oven dried. Properties of the resulting material are recorded in Table 1 below.

TABLE I
Properties of Samples

| | | Example 2 | | Example 4 |
|---|---|---|---|---|
| | | 45% USY | | 35% USY |
| | Example 1 | 10% Al2O3(alum) | Example 3 | 8% Al2O3(Alum) |
| | 45% USY | 10% Al2O3 | 35% USY | 10% Al2O3 |
| | 10% Al2O3(alum) | (Boehmite) | 8% Al2O3(alum) | (Boehmite) |
| | 45% Clay | 35% Clay | 57% Clay | 47% Clay |
| Al2O3 | 40.3 | 42.8 | 39.2 | 43.5 |
| Na2O | 0.24 | 0.25 | 0.19 | 0.2 |
| SO4 | 2.18 | 2.5 | 2.06 | 2.09 |
| RE2O3 | 2.71 | 2.55 | 2.27 | 2.35 |
| APS | 81 | 79 | 66 | 68 |
| DI | 8 | 9 | 6 | 7 |
| eolite SA | 278 | 266 | 223 | 233 |
| fatrix SA | 62 | 60 | 50 | 57 |

| | Example 5 | Example 6 | Example 7 | Example 8 |
|---|---|---|---|---|
| | 25% USY | 25% USY | 40% USY | 40% USY |
| | 6% Al2O3(alum) | 6% Al2O3(alum) | 6% Al2O3(alum) | 6% Al2O3(alum) |
| | 25% Al2O3 | 25% Al2O3 | 25% Al2O3 | 25% Al2O3 |
| | (Boehmite) | (Boehmite) | (Hipal-30) | (Hipal-40) |
| | 44% Clay | 44% Clay | 29% Clay | 29% Clay |
| Al2O3 | 52.4 | 54.7 | 52.7 | 51.5 |
| Na2O | 0.2 | 0.21 | 0.31 | 0.33 |
| SO4 | 3.22 | 0.82 | 2.35 | 2.19 |
| RE2O3 | 2.67 | 2.44 | 3.96 | 3.93 |
| APS | 67 | 72 | 82 | 69 |
| DI | 7 | 16 | 7 | 8 |
| eolite SA | 164 | 164 | 255 | 262 |
| fatrix SA | 111 | 110 | 143 | 125 |

Alum: Aqueous aluminum sulfate solution.

### Example 9

Samples from Examples 1-6 above were deactivated in a fluidized bed for 4 hours at 815° C. in 100% steam environment. Samples from Examples 7 and 8 were deactivated in the presence of the 2000 ppm Ni and 3000 ppm V, using the deactivation method described herein below.

The samples were heated 1 hour at 400° F., then 3 hours at 1100° F. After cooling down, the 2000 ppm Ni and 3000 ppm V from naphthenates are impregnated by incipient wetness. Then the sample is heated 1 hour at 400° F., then 3 hours at 1100° F. Then 100 grams of the impregnated sample is charged to a quartz reactor tube 25½ inch length×1.18-inch diameter. Under nitrogen purge, heat reactors from room temperature to 1440° F. over 2½ hours and equilibrate. Start steam and raise temperature to 1450° F. during the first 5 minutes.

The samples were steam deactivated as follows: 1450° F., 50 wt % Steam, 0 psig, 20 hours with thirty cycles consisting of ten minute purge of 50 wt % nitrogen, then a ten minute 50 wt % air stream with SO₂ (4000 ppm), then a ten minute purge of 50 wt % nitrogen, then a ten minute 50 wt % stream of 5% propylene in N₂. In the end the reactor is cooled down by a N₂ purge.

The deactivated catalyst samples were tested for their ability to crack a hydrocarbon feed, using the fixed bed MAT reactor (ASTM#D-3907-92) at a reactor temperature of 527° C. and a cat to oil ratio of 4. The properties of the feed used for the testing are shown in Table 2 below. The activity of each sample to crack the hydrocarbon feed is shown in Table 3 below.

TABLE 2
Feed Properties

| | |
|---|---|
| API @ 60 F. | 22.5 |
| Aniline Point, of | 163 |
| Sulfur, wt % | 2.59 |
| Total Nitrogen, wt % | 0.086 |
| Basic Nitrogen, wt % | 0.034 |
| Conradson Carbon, wt. % | 0.25 |
| Ni, ppm | 0.8 |
| V, ppm | 0.6 |
| Fe, ppm | 0.6 |
| Na, ppm | 0.6 |
| Cu, ppm | 0.1 |
| K Factor | 11.46 |
| Specific Gravity @ 60 F. | 0.9186 |
| Bromine Number | 26.78 |
| Refractive Index | 1.5113 |
| Average Molecular Weight | 345 |
| Paraffinic Carbons Cp, wt. % | 57.4 |
| Naphthenic Ring Carbons Cn, wt. % | 21.2 |
| Aromatic Ring Carbons Ca, wt. % | 21.5 |
| Distillation, Initial Boiling Point | 352 F. |
| Distillation, 5% | 531 F. |
| Distillation, 10% | 577 F. |
| Distillation, 20% | 630 F. |
| Distillation, 30% | 675 F. |
| Distillation, 40% | 714 F. |
| Distillation, 50% | 750 F. |
| Distillation, 60% | 788 F. |
| Distillation, 70% | 826 F. |
| Distillation, 80% | 871 F. |
| Distillation, 90% | 925 F. |
| Distillation, 95% | 963 F. |
| Distillation, End Point | 1038 F. |

TABLE 3
Catalytic Cracking Activity

| Example No. | Cracking Activity |
|---|---|
| 1 | 79.0 wt % |
| 2 | 77.2 wt % |
| 3 | 78.6 wt % |
| 4 | 76.1 wt % |
| 5 | 79.4 wt % |
| 6 | 76.8 wt % |
| 7 | 69.9 wt % |
| 8 | 74.9 wt % |

### Example 10

Samples of a catalytic material prepared as described in Example 2 and a aluminum chlorohydrol bound catalyst, Ultima 2056 obtained from W.R. Grace & Co.-Conn. in Columbia, Md., having the properties as shown in Table 4 below were deactivated in a fluidized bed for 4 hours at 815° C. in 100% steam environment. These deactivated samples were evaluated in ACE Model AP Fluid Bed Microactivity unit (from Kayser Technology, Inc.) at 527° C. Three runs were carried out for each catalyst using the catalyst to oil ratio of 4, 6 and 8. The catalyst to oil ratio was varied by changing the catalyst weight and keeping the feed weight constant. The feed weight utilized for each run was 1.5 g, and the feed injection rate was 3.0 g/minute. Properties of the feed used for ACE testing are shown in Tables 4 and 5 below:

TABLE 4

| | |
|---|---|
| Al₂O₃ wt %: | 45.8 |
| Na₂O wt %: | 0.43 |
| SO₄ wt %: | 0.55 |
| RE₂O₃ wt %: | 3.15 |
| APS: | 70 |
| DI: | 2 |
| Zeolite SA: | 274 |
| Matrix SA: | 54 |

TABLE 5
Feed Properties

| | |
|---|---|
| API @ 60° F. | 25.5 |
| Aniline Point, oF | 196 |
| Sulfur, wt % | 0.396 |
| Total Nitrogen, wt % | 0.12 |
| Basic Nitrogen, wt % | 0.05 |
| Conradson Carbon, wt. % | 0.68 |
| Ni, ppm | 0.4 |
| V, ppm | 0.2 |
| Fe, ppm | 4 |
| Na, ppm | 0 |
| Cu, ppm | 1.2 |
| K Factor | 11.94 |
| Specific Gravity @ 60° F. | 0.9012 |
| Refractive Index | 1.5026 |
| Average Molecular Weight | 406 |
| Paraffinic Carbons Cp, wt. % | 63.6 |
| Naphthenic Ring Carbons Cn, wt. % | 17.4 |
| Aromatic Ring Carbons Ca, wt. % | 18.9 |
| Distillation, Initial Boiling Point | 307° F. |
| Distillation, 5% | 513° F. |
| Distillation, 10% | 607° F. |
| Distillation, 20% | 691° F. |
| Distillation, 30% | 740° F. |
| Distillation, 40% | 782° F. |
| Distillation, 50% | 818° F. |
| Distillation, 60% | 859° F. |
| Distillation, 70% | 904° F. |
| Distillation, 80% | 959° F. |
| Distillation, 90% | 1034° F. |
| Distillation, 95% | 1103° F. |
| Distillation, End Point | 1257° F. |

The yields, at constant conversion, obtained from ACE testing are shown in Table 6 below. Catalyst samples of Example 2 exhibited enhanced performance, i.e. lower coke product and increased bottoms cracking, as compared to yields obtained from a conventional aluminum chlorohydrol bound cracking catalyst composition.

TABLE 6

| | Example 2 | Example 10 |
|---|---|---|
| Conversion, wt % | 78 | 78 |
| Cat-to-Oil Ratio | 6.02 | 6.04 |
| Hydrogen, wt % | 0.07 | 0.05 |
| Ethylene, wt % | 0.68 | 0.70 |
| Total Dry Gas, wt % | 1.88 | 1.89 |
| Propane, wt % | 1.26 | 1.33 |
| Propylene, wt % | 5.44 | 5.35 |
| Total C3's, wt % | 6.72 | 6.69 |
| n-Butane, wt % | 1.18 | 1.27 |
| Isobutane, wt % | 5.57 | 5.76 |
| Isobutene, wt % | 1.57 | 1.45 |
| Total C4═, wt % | 6.06 | 5.82 |
| Total C4's, wt % | 12.86 | 12.90 |
| Total Wet Gas, wt % | 21.47 | 21.49 |
| C5+ Gasoline, wt % | 52.51 | 52.33 |
| LCO, wt % | 17.27 | 17.00 |
| Bottoms, wt % | 4.73 | 5.00 |
| Coke, wt % | 3.75 | 3.92 |

1-22. (canceled)

23. A method of forming a particulate composition of matter having a Davison Index of less than 30, said method comprising
a) forming an aqueous slurry comprising a plurality of inorganic metal oxide particles and aluminum sulfate in an amount sufficient to provide at least 5 wt % alumina in a final particulate inorganic metal oxide composition;
b) optionally, milling the slurry;
c) spray drying the slurry to form inorganic metal oxide particles bound by aluminum sulfate;
d) optionally, calcining the aluminum sulfate bound metal oxide particles;
e) re-slurrying the aluminum sulfate bound inorganic metal oxide particles in an aqueous base solution at a pH of about 7 to about 13 for a time and at a temperature sufficient to remove all or substantially all sulfate ions; and;
f) recovering and drying the resulting inorganic metal oxide composition to obtain a final inorganic metal oxide composition bound with alumina obtained from aluminum sulfate.

24. The method of claim 23 wherein aluminum sulfate is present in the slurry in an amount sufficient to provide about 5 to about 25 wt % of the alumina in the final inorganic metal oxide composition.

25. The method of claim 23 wherein the aluminum sulfate bound particles are calcined at temperatures ranging from about 150° C. to about 600° C. for about 2 hours to about 10 minutes.

26. The method of claim 23 wherein the temperature during the re-slurry step ranges from about 1° C. to about 100° C. for about 1 minute to about 3 hours.

27. A method of forming a catalytic cracking catalyst composition having a Davison Index of less than 30, said method comprising
a) forming an aqueous slurry comprising at least one zeolite particle having catalytic cracking activity under catalytic cracking conditions and aluminum sulfate in an amount sufficient to provide at least 5 wt % alumina in a final catalyst composition;
b) milling the slurry;
c) spray drying the milled slurry to form particles;
d) calcining the spray-dried particles at a temperature and for a time sufficient to remove volatiles;
e) re-slurrying the calcined particles in an aqueous base solution at a pH of about 7 to about 13 for a time and at a temperature sufficient to remove all or substantially all sulfate ions; and
f) recovering and drying the resulting particles to obtain a final catalyst composition comprising at least 5 wt % alumina obtained from aluminum sulfate.

28. The method of claim 27 wherein aluminum sulfate is present in the slurry in an amount significant to provide about 5 to about 25 wt % alumina obtained from aluminum sulfate in the final catalyst composition.

29. The method of claim 27 wherein the spray-dried particles are calcined at temperatures ranging from about 150° C. to about 600° C. for about 2 hours to about 10 minutes.

30. The method of claim 27 wherein the temperature during the re-slurry step ranges from about 1° C. to about 100° C. for about 1 minute to about 3 hours.

31. The method of claim 27 wherein the at least one zeolite comprise faujasite zeolite.

32. The method of claim 31 wherein the faujasite zeolite is selected from the group consisting of Y-type zeolite, USY zeolite, REUSY zeolite, or a mixture thereof.

33. The method of claim 32 wherein the zeolite is partially exchanged with ions selected from the group consisting of rare earth metals ions, alkaline earth metal ions, ammonium ions, acid ions and mixtures thereof.

34. The method of claim 27 wherein the slurry further comprises clay.

35. The method of claim 27 wherein the slurry further comprises at least one matrix material selected from the group consisting of alumina, silcica, silica-alumina, oxides of transition metals selected from Groups 3, 4, 5, 6, 7, 8, 9, 10, 11, 12 of the New Notations of the Periodic Table, oxides of rare earth metals, oxides of alkaline earth metals and mixtures thereof.

36-38. (canceled)

39. The method of claim 34 wherein the slurry further comprises at least one matrix material selected from the group consisting of alumina, silcica, silica-alumina, oxides of transition metals selected from Groups 3, 4, 5, 6, 7, 8, 9, 10, 11, 12 of the New Notations of the Periodic Table, oxides of rare earth metals, oxides of alkaline earth metals and mixtures thereof.
